(19) United States
(12) Patent Application Publication
(10) Pub. No.: US 2024/0307891 A1
(43) Pub. Date: Sep. 19, 2024

(54) ELECTROSTATIC PRECIPITATOR CLEANING

(71) Applicant: Edwards Limited, Burgess Hill, Sussex (GB)

(72) Inventors: James Hann, Clevedon, Somerset (GB); Andrew James Seeley, Clevedon, Somerset (GB)

(21) Appl. No.: 18/578,387

(22) PCT Filed: Jul. 12, 2022
(86) PCT No.: PCT/GB2022/051792

§ 371 Date: Jan. 11, 2024

(30) Foreign Application Priority Data
Jul. 22, 2021 (GB) 2110579.6

(51) Int. Cl. B03C 3/74; B03C 3/16; B03C 3/70; B03C 3/78; B03C 3/80

(52) U.S. Cl. CPC B03C 3/743; B03C 3/16; B03C 3/70; B03C 3/78; B03C 3/80

(57) ABSTRACT

A wet electrostatic precipitator includes an ancillary component cleaning device with a cleaning assembly moveably supportable within an electrostatic precipitator; the cleaning assembly having a scraper configurable to abut an ancillary component of the electrostatic precipitator, such that movement of the cleaning assembly within the electrostatic precipitator causes movement of the scraper with respect to the ancillary component and wherein the ancillary component includes a component of a separation assembly provided in the wet electrostatic precipitator to maintain electrical isolation between the discharge and collection electrodes.

### CROSS-REFERENCE OF RELATED APPLICATION

This application is a Section 371 National Stage Application of International Application No. PCT/GB2022/051792, filed Jul. 12, 2022, and published as WO 2023/002157A1 on Jan. 26, 2023, the content of which is hereby incorporated by reference in its entirety and which claims priority of British Application No. 2110579.6, filed Jul. 22, 2021.

### FIELD

The field of the invention relates to a wet electrostatic precipitator comprising an ancillary component cleaning device and a method of cleaning a wet electrostatic precipitator.

### BACKGROUND

Electrostatic precipitator devices collect dust and particulate contaminants from gas, for example, from air or from exhaust gases formed as part of an industrial process. Electrostatic precipitator devices collect contaminants by using an electrostatic force. For example, an electrostatic precipitator device may be configured to generate electrons by means of corona discharge. The generated electrons ionise surrounding air or other gas molecules. Ionised gas molecules within the electrostatic precipitator device combine with particulate matter carried in the air or exhaust gas. As a result, particulates become charged and may be attracted to appropriately grounded collection electrodes by electrostatic force.

Electrostatic precipitator devices may comprise one or more collection electrodes which are electrically grounded and one or more discharge electrodes, to which a high voltage is applied. When a high voltage is applied to the discharge electrodes, a corona discharge forms between the discharge electrodes and the collection electrodes. Collection and discharge electrodes are both typically electrically conductive.

Efficient operation of an electrostatic precipitator device may depend upon the nature of the corona discharge between the discharge electrode and the collection electrode. For example, increasing a distance between the discharge electrode and the collection electrode results in reduced efficiency and requires a larger voltage to be applied to the discharge electrode to enable the appropriate efficiency to be restored. Similarly, decreasing the distance between the discharge electrode and the collection electrode improves efficiency, but electrical breakdown is more likely at reduced distances which may render the electrostatic precipitator inoperable.

Particulate build up within an electrostatic precipitator can have a detrimental impact upon efficient operation of an electrostatic precipitator device. A build-up of particulate matter can cause short circuiting and/or a corona discharge to form in a manner which does not support efficient overall operation of the electrostatic precipitator device. Wet electrostatic precipitator devices use fluid, for example, water, to clean one or more main components of the precipitator device.

Aspects and embodiments may offer a mechanism to ameliorate particulate build up and improve efficient operation of a wet electrostatic precipitator device.

The discussion above is merely provided for general background information and is not intended to be used as an aid in determining the scope of the claimed subject matter. The claimed subject matter is not limited to implementations that solve any or all disadvantages noted in the background.

### SUMMARY

One aspect provides a wet electrostatic precipitator comprising an ancillary component cleaning device, the cleaning device comprising: a cleaning assembly moveably supportable within the wet electrostatic precipitator; the cleaning assembly comprising a scraper; the scraper being configurable to abut an ancillary component of the wet electrostatic precipitator, such that movement of the cleaning assembly within the wet electrostatic precipitator causes movement of the scraper with respect to the ancillary component and wherein the ancillary component comprises a component of a separation assembly provided in the wet electrostatic precipitator to maintain electrical isolation between the discharge and collection electrodes.

Accordingly, alongside primary particulate clearing and cleaning mechanisms provided to the main components of a wet electrostatic precipitator, a secondary or supplementary clearing arrangement may be provided to assist in clearing one or more ancillary components of the wet electrostatic precipitator. Accordingly, by clearing components other than the primary electrodes, general particulate or agglomerate build up can be mitigated and efficient operation of the primary components of the electrostatic precipitator may be maintained for a greater period than may be expected without the ancillary component clearing. In some arrangements, the ancillary component to be cleared by the cleaning device comprises a component located adjacent a primary electrostatic precipitator component. Accordingly, particulate or agglomerate build up on such a component may be such that, if not cleared, contact with the primary component may be made, and operation of the primary component(s) detrimentally impacted. Aspects may be provided as a supplementary clearing device and are not configured to clear the primary electrostatic precipitator components, for example, a precipitator discharge or collection electrode.

According to some embodiments, the ancillary component may comprise a component of a separation assembly provided in an electrostatic precipitator to maintain electrical isolation between the discharge and collection electrodes. Accordingly, mitigating a build up of particulate or agglomerate on ancillary components provided and located to maintain separation of discharge and collection electrodes may help to prevent undesirable contact occurring between those electrodes.

According to some embodiments, movement of the cleaning assembly within the electrostatic precipitator causes movement of the scraper along a surface or edge of the ancillary component. The motion of the scraper along the surface or edge may help to dislodge or clear particulate or agglomerate build up on the edge or surface.

According to some embodiments, the scraper comprises a narrow elongate element. Provision of a scraper having a small surface area helps to avoid build-up of particulate or agglomerate on the scraper itself. A scraper having a small contact area with the ancillary component may allow for more effective clearing, by virtue of increased pressure on the edge or contact portion of the scraper with the ancillary component.

According to some embodiments, the scraper comprises a wire. According to some embodiments, the scraper is electrically earthable. According to some embodiments, contact between the scraper and ancillary component causes electrical earthing of the scraper. Accordingly, the earthing of the scraper may aid prevention of any build up of particulate or agglomerate on the scraper itself.

According to some embodiments, the device is coupleable to a motor configured to move the cleaning assembly relative to the ancillary component. According to some embodiments, the device is arrangeable within the electrostatic precipitator such that the cleaning assembly is carried by a flow of cleaning fluid to move the body relative to the ancillary component. According to some embodiments, the cleaning fluid comprises a flow of water configured to clean at least one collection electrode surface in the electrostatic precipitator device. According to some embodiments, the cleaning fluid comprises a continuous or pulsed flow of gas configured to clean at least one collection electrode surface in the electrostatic precipitator device. Accordingly, relative movement between the scraper of the cleaning device and the ancillary component may be implemented in various active or passive ways. Implementation of a device which utilises a passive drive mechanism may allow for provision of an ancillary component clearing device which can be retrofitted to existing electrostatic precipitators.

According to some embodiments, the electrostatic precipitator comprises a primary component clearing mechanism. The primary component may comprise a discharge or collection electrode. The clearing mechanism may comprise one or more of: a washing mechanism, rapping mechanism or air blasting mechanism.

A further aspect provides a method of cleaning an ancillary component of a wet electrostatic precipitator comprising: providing a cleaning device comprising a cleaning assembly comprising a scraper; arranging the cleaning assembly of the cleaning device to be moveably supported within the wet electrostatic precipitator; configuring the scraper to abut the ancillary component of the wet electrostatic precipitator, such that movement of the cleaning assembly within the wet electrostatic precipitator causes movement of the scraper with respect to the ancillary component and wherein the ancillary component comprises a component of a separation assembly provided in the wet electrostatic precipitator to maintain electrical isolation between the discharge and collection electrodes.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

Embodiments of the present invention will now be described further, with reference to the accompanying drawings, in which:

FIG. 1 illustrates an example electrostatic precipitator;

FIG. 2 is a magnified view of a portion of the example electrostatic precipitator of FIG. 1;

FIG. 3 illustrates as a perspective view, a water feed plate 120 such as that shown in the electrostatic precipitator of FIGS. 1 and 2;

FIG. 4 is a photograph showing some of the main components of a precipitator such as that shown in FIGS. 1 and 2;

FIG. 5 is a photograph showing some of the main components of a precipitator such as that shown in FIGS. 1 and 2;

FIG. 6 illustrates a clearing device according to one example embodiment suitable for use in an electrostatic precipitator such as that shown in FIG. 1 and FIG. 2;

FIG. 7 illustrates an alternative clearing device according to one example embodiment suitable for use in an electrostatic precipitator such as that shown in FIG. 1 and FIG. 2; and

FIG. 8 is a photograph showing some of the main components of a WESP such as that shown in FIGS. 1 and 2, in which a device such as that shown in FIG. 6 is operational.

### DETAILED DESCRIPTION

Before discussing the embodiments in any more detail, first an overview will be provided. Embodiments provide an arrangement which operates to support efficient operation of an electrostatic precipitator device. Arrangements seek to provide a mechanism and method to reduce build-up of particulates, thereby supporting reliable generation of a corona discharge within an electrostatic precipitator.

An electrostatic precipitator typically operates to remove particulate matter from a gas by enabling ionisation of the particulate matter and making use of electrostatic forces. A corona discharge is formed in by providing at least one discharge electrode held at a high voltage and at least one collection electrode held electrically at earth. The resulting corona discharge forms ionised particles in a gas between the electrodes.

The collection electrodes or “earth plates” in an electrostatic precipitator (ESP) collect particulates as a result of charged particles being attracted to those plates.

The particulates can then be removed from the collection electrodes and other electrically neutral or earthed regions. A dry electrostatic precipitator device may be such that particulates are removed by rapping (a process of physically vibrating or hitting the electrode plates to dislodge particulate build up) the collection electrodes, or by air blasting the collection electrodes. In a wet electrostatic precipitator (WESP) the collection electrodes are typically washed by a fluid, for example, water, to prevent particulate build up. Arrangements recognise that in some applications, particulates can form solid agglomerates on components other than the primary collection electrodes and that typical particulate removal techniques may be ineffective.

It will be appreciated that if particulates excessively build up on a collection electrode (or discharge electrode) the build-up can lead to issues including: a decrease in electrode-plate separation distance thus leading to intermittent electrical arcing which may reduce particulate removal performance; a decrease in electrode-plate separation distance may lead to full electrical shortage and subsequently a loss of particulate charging entirely rendering an ESP non-operational; a decrease in electrode-plate separation may lead to intermittent arcing which consequently requires use of higher capacity power supplies; and, the build-up of particulate on the earth surface may lead to back-corona, consequently increasing draw of current from a power supply.

Described arrangements recognise that in some electrostatic precipitator devices, there may be ancillary components (ie components other than the discharge and collection electrodes) that are earthed or electrically neutral which cannot be rapped, air blasted or washed due to the close proximity of those earthed components to high voltage components or other essential primary components of the electrostatic precipitator. Rapping or washing in relation to closely spaced components can, for example, lead to an unexpected connection and electrical shorting between those closely spaced components. Furthermore, described arrangements recognise that a particular application chosen for some electrostatic precipitator devices may result in agglomeration of particulate matter which can be problematic to remove via standard rapping, air blasting and/or washing techniques. Arrangements recognise that it may be possible to use mechanical scraping as a mechanism to clean one or more ancillary component surfaces within an ESP. Maintaining cleaner surfaces even in relation to ancillary components of a precipitator, particularly those located in the immediate vicinity of the primary functional components, may make it possible to elongate the time an ESP can remain in efficient operation before faults resulting from particulate build-up occur.

Mechanical scraping of ESP components may be achieved in various ways. A scraper may comprise an element having a scraping edge or surface configured to engage with a surface of a component to be cleared. The scraping edge may be moveable across one or more surfaces or edges of a component to be cleared. Motion of the scraper may occur by virtue of selection and application of an appropriate electromechanical configuration, for example, by appropriate coupling of a scraper to a motor. Motion of the scraper may occur as a result of one or more components or fluids associated with standard operation of an ESP or WESP, for example, as a result of a flow of a cleaning fluid already used to wash an earthed collection electrode, or movement effected by an air blast arrangement already in operation within an ESP.

### Electrostatic Precipitator

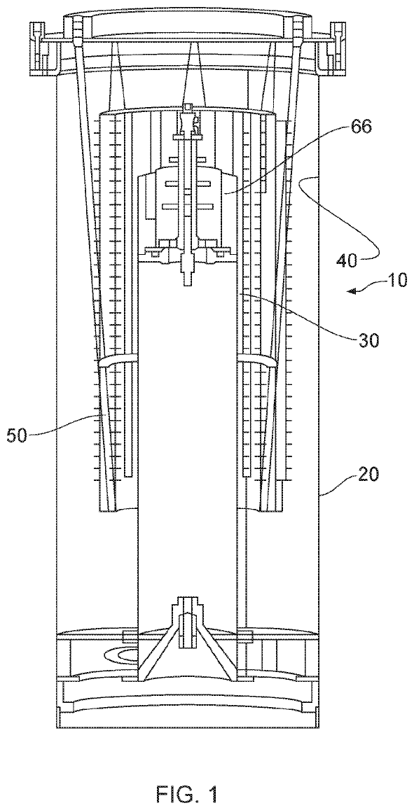

FIG. 1 illustrates an example electrostatic precipitator 10. The electrostatic precipitator 10 comprises a housing 20 having inlets (not shown) which receive an effluent stream and outlets (not shown) which provide a treated effluent stream. In this example electrostatic precipitator, the housing 20 is generally cylindrical in shape. However, it will be appreciated that the housing 20 may be of any suitable shape and that the inlets and the outlets may be located at any suitable position.

The electrostatic precipitator 10 shown in FIG. 1 comprises a wet electrostatic precipitator (WESP) and comprises a cylindrical inner earthed plate forming a collection electrode 30, a cylindrical outer earthed plate forming a collection electrode 40, and a discharge electrode cage 50. The discharge electrode cage 50 is held at high voltage, for example, 5-50 kV and, in the example shown, the cylindrical inner collection electrode 30 is washed.

In order to maintain ESP structure and to maintain separation between components of the electrostatic precipitator 10, in the example shown, the discharge electrode cage 50 is mechanically coupled to the inner collection electrode 30. Electrical isolation between the electrode cage 50 and the earthed inner collection electrode is maintained by ensuring the mechanical coupling or connection between the two components includes an electrically insulating element.

It will be appreciated that efficient operation of an electrostatic precipitator device depends upon maintenance of high voltage potential surfaces fully electrically isolated from earthed collection plates. In the example shown, the earthed inner cylindrical collection electrode structure 30 is washed continuously. An additional physical barrier in the form of a separator or guard 66 is provided between a water flow acting to wash the collection electrode 30 and the insulating element forming part of the mechanical coupling. The barrier may itself form part of the mechanical coupling. Without such a barrier or guard, the electrically insulating element forming part of the mechanical coupling between the discharge electrode cage 50 and washed collection electrode 30 could get wet. A wet surface is no longer electrically insulating. The wet surface could provide an electrical leakage path for high voltage and as a result, the ESP device could fail.

Ancillary components such as the mechanical coupling, insulating element and barrier are examples of components within an ESP on which particulate matter may collect and negatively impact upon operation of the ESP, but which may not be cleared as part of standard operation of the ESP.

Described arrangements recognise that despite various existing mechanisms to mitigate the chance of ESP failure, it is possible to further mitigate the chance of ESP failure if mechanisms are provided to reduce build-up of particulate matter on ancillary ESP components where other clearing approaches may be unsuitable. By way of example, it is possible for particulate matter to build up on the mechanical coupling between the discharge electrode and collection electrode. Particulate matter may also, for example, build up on the separator or barrier referred to above. The build-up of particulate matter on a component of the mechanical coupling, for example, the separation barrier, can still cause issues with ESP operation. Such ancillary components cannot be easily rapped and cannot be washed with water due to the possibility of affecting the electrical isolation of main operational components of an ESP. The distance between ancillary components of the ESP which cannot be washed or rapped may be increased in some cases to combat the particulate build-up but this is at the expense of an increase in the overall design footprint. Arrangements described in more detail below provide alternative mechanisms for clearing particulate build up from components of an ESP. In particular, arrangements recognise that is it possible to support mechanical cleaning of such components.

Mechanical cleaning may take the form of mechanically loosening, moving or scraping particulate matter from a surface and/or edge of one or more ESP component. The mechanical cleaning may be implemented in various ways. In general, a mechanical cleaning device may be provided which includes at least one component arranged to contact a surface or edge of an ESP component to be cleared of a build-up of particulate matter. The component arranged to contact a surface or edge of the ESP component may comprise a scraper. The scraper may comprise a scraping edge or surface configured to engage with at least a portion of the surface or edge of the component to be cleared. The scraping edge may be moveable across one or more surfaces or edges of a component to be cleared. The scraping edge, for example, may comprise a scraping wire. The scraping edge or element may have a low surface area so that appreciable amounts of particulates or agglomerates cannot adhere to it. The scraping element may itself be held electrically at earth.

The mechanical cleaning device may be actively powered or be a passive device, moved as a result of one or more factor already associated with standard operation of an ESP or WESP, for example, as a result of a flow of cleaning fluid, or flow of gas, already required to clean by washing or blowing an earthed collection electrode.

By way of example, operation of a WESP, components of a WESP and a mechanical cleaning device according to one example embodiment are described in detail.

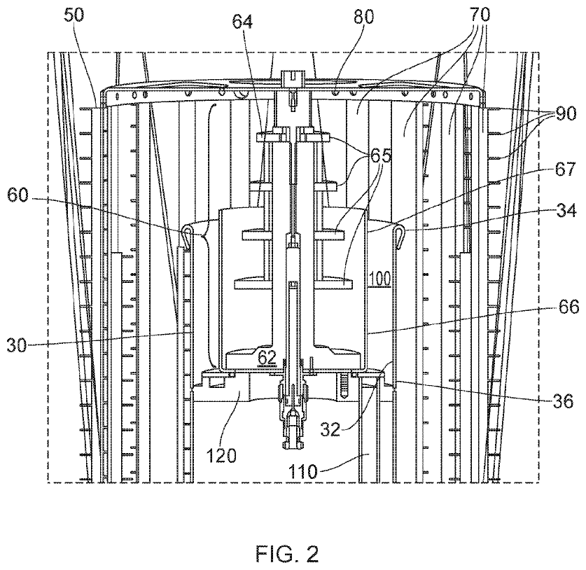

FIG. 2 is a magnified view of a portion of the wet electrostatic precipitator of FIG. 1. FIG. 2 shows a mechanical coupling 60 between discharge electrode cage 50 and inner wet collection electrode 30. The mechanical coupling 60 is received within the housing 20. In this embodiment, the mechanical coupling 60 is coaxially located within the housing 20. The mechanical coupling 60 is dimensioned to be spaced away from surfaces of the hollow housing 20 and extends along an elongate axis of the housing 20. An electrical coupling (not shown) couples to the discharge electrode cage 50. The mechanical coupling 60 is electrically isolated from the housing 20. The discharge electrode cage 50 comprises a number of shafts 70. In this example, the shafts 70 are elongate plates extending along the elongate axis of the housing 20 from an annular support 80. The shafts 70 are positioned circumferentially around the annular support 80. A number of axially spaced teeth 90 extend radially from each of the shafts 70. In the example shown, the teeth 90 are integrally formed with the shafts 70. In particular, the shaft 70 and the teeth 90 are formed from a metal plate which is stamped or cut to form the comb structure. Conveniently, the shafts 70 may be bent or folded to provide a surface for fixing to the annular support 80.

The discharge electrode cage 50 and inner collection electrode 30 are connected by the mechanical coupling 60. The mechanical coupling 60 comprises an elongate shaft 62 and an insulating element 64. The insulating element ensures that whilst discharge electrode cage 50 and inner collection electrode 30 are mechanically connected they are not electrically connected. In the example shown, the insulator comprises a series of axially spaced annular plate-like elements 65 which serve as an electrical insulator and electrical guard in the region of the ends of the substantially cylindrical concentrically arranged inner wet collection electrode 30 and discharge electrode cage 50. The plate-like elements 65 also form a physical barrier between those ESP components. The mechanical coupling 60 includes a barrier or guard 66 in the form of an open-ended cylinder arranged between wet the inner collection electrode 30 and the insulating element 64. The guard 66 acts as a barrier between fluid used to wash the wet collection electrode 30 and the insulating element 64. In the arrangement of FIG. 2, the guard 66 extends axially beyond the end of collection electrode 30 to protect insulating element 64 from splashes of liquid used to clean the collection electrode 30.

In the arrangement of FIG. 2, wet cleaning of electrode 30 is implemented. An internal water reservoir (not shown in FIG. 2) collects in a cavity 100 formed between an inner surface 32 of the hollow cylindrical collection electrode 30 and an outer surface 67 of the barrier 66. A water feed 110 provides a supply of water to the cavity 100 via a feed plate 120, shown in more detail in a later figure. Water from the feed 110 fills the cavity 100 until water level in the cavity reaches a top lip 34, in the form of a water-weir lip, of the inner collection electrode 30. Water pours over the water-weir lip 34 and onto an outer surface 36 of the collection electrode 30.

In operation, as described previously, the discharge electrode cage 50 is held at a high potential to cause a corona discharge. The corona discharge causes ionisation of particulate matter within an ESP, which is then attracted to an outer surface of the earthed collection electrodes 30, 40 in the ESP. In the example shown in FIG. 2, the outer surface 36 of the inner electrode is washed with water to clear that particulate collection. Substantially continuous clearing of the outer surface 36 can be achieved by allowing water within cavity 100 to pass over the weir lip 34 and to then pass along the outer surface 36, washing away collected particulate matter. The presence of water on outer surface 36 does not impact the potential difference between the discharge electrode cage 50 and the collection electrode 30.

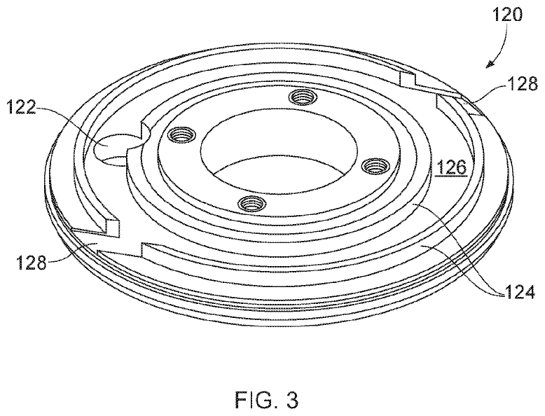

FIG. 3 illustrates as a perspective view, a water feed plate 120 such as that shown in the electrostatic precipitator of FIGS. 1 and 2. Water feed plate 120 takes the form of a substantially annular plate and, as shown in FIG. 2, can be located immediately beneath barrier 66 of the mechanical coupling 60. The feed plate 120 includes an opening 122 to allow ingress of water from water feed 110. Baffles 124 formed on the plate 120 together form one or more channels 126 through which the ingress of water from the water feed is forced. Water entering the plate 120 from the water feed exits the plate tangentially via outlets 128 into cavity 100. The water in cavity 100 has a “whirlpool” circulatory motion as a result of the tangential release of feed water from the outlets 128 of the feed plate.

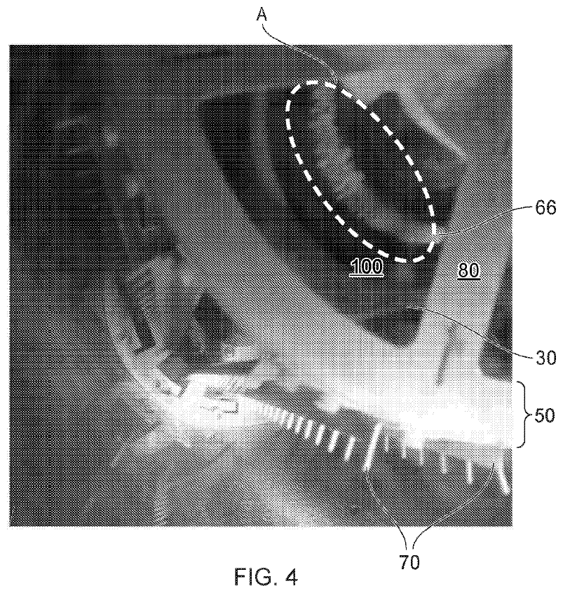

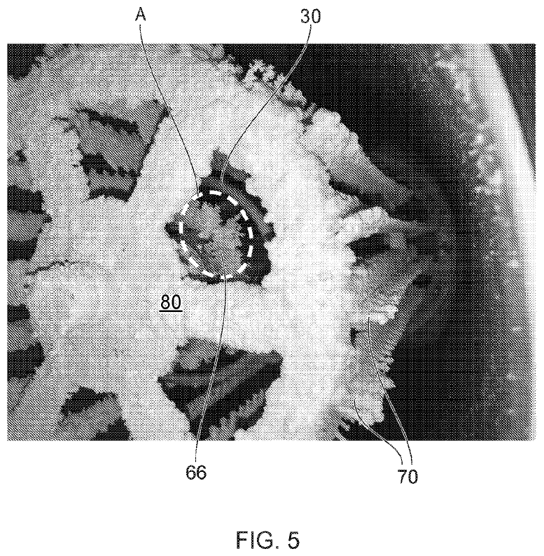

FIGS. 4 and 5 are photographs showing some of the main components of a WESP such as that shown in FIGS. 1 and 2, in which particulate build-up can be seen. In particular, FIG. 4 is a photograph along the axis of the ESP from electrode cage 50 annular support 80. The shafts 70 of the electrode cage 50 can be seen extending away from the camera. The cavity 100 which, in use, receives a water reservoir can be seen, formed between the collection electrode 30 and the barrier 66. Despite being generally clean, the photographed WESP components include a region A of particulate build up on the upper edge of barrier 66. As explained earlier, the barrier 66 is not washed, nor can it be air blasted or rapped to remove particulate matter. The build-up of particulate matter in region A can impact negatively upon overall ESP operation.

FIG. 5 is a similar photographic view of the internal components of a WESP such as that shown in FIGS. 1 to 3. In this instance, all components are exhibiting particulate build up, including significant particulate build up in region A, at the edge of barrier 66 (also known as the insulator surround).

It has been found that the build up of particulate matter in regions such as region A shown in FIGS. 4 and 5, can result in an ESP displaying back-corona glow whilst in operation. Back-corona glow resulting from particulate build up significantly increases ESP power draw from a power supply. For best overall ESP performance electrode current is matched to a power supply. If additional current flows due to the formation of a back corona glow, the ESP system ends up drawing more power than is strictly required to only remove particulate matter in a processed fluid.

Arrangements recognise that it is possible to provide a device which can support clearing of particulate matter from one or more earthed or neutral component within a electrostatic precipitator.

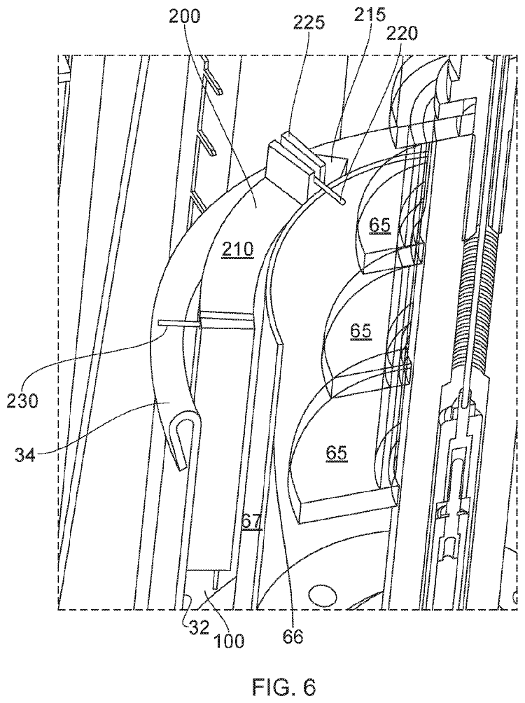

FIG. 6 illustrates a clearing device 200 in accordance with one example embodiment suitable for use in an electrostatic precipitator such as that shown in FIG. 1 and FIG. 2. The device 200 comprises a cleaning assembly including a body 210 which supports a scraper 220. In the example shown, the device is dimensioned to be locatable within the cavity 100 formed between the inner collection electrode 30 and the barrier 66. In particular, the body is dimensioned such that it can be adjacent to, but spaced apart from, the inner surface 32 of the collection electrode 30 and the outer surface 67 of the barrier 66. The device body 210 has a curvature selected such that it conforms to the space between the inner collection electrode 30 and the barrier 66. Such a selection of dimensioning and shaping allows the device 200 to freely circulate in cavity and allows the body to carry the scraper 220 on a path which circumnavigates the barrier 66. The body 210 of the device extends down into the cavity 100 and is at least partially submerged within the reservoir of cleaning fluid within the cavity 100. The body 210 of the device may be formed from a material which prevents the device 200 floating in the water, or other cleaning fluid, supplied to cavity 100. The material selected for the body of the device is also not so dense or the device so heavy to prevent movement of fluid within the reservoir acting to carry the device 200 along.

The material and weight of the device is carefully selected such that the device 200 does not simply float at the surface of the reservoir, and is prevented from sinking into cavity 100 by scraper 210 resting on an upper edge of the barrier 66. The body of the device is kept upright by provision of a support 230 which is arranged on the body such that, in use, it rests upon the water weir lip 34 of the inner collection electrode 30. In other words, the body of the device is suspended from the scraper 220 and support 230, such that it is located within the cavity, touching neither the inner surface 32 of the collection electrode 30 nor the outer surface 67 of the barrier 66. Because the axial length of the barrier is such that it extends axially beyond the length of the collection electrode, the scraper 220 is held in a slot provided in a scraper support 225 which projects from an upper surface of the device body 210, whilst the stabilising support 230 is held in position within a slot which extends down into the device body itself.

In use, circumferential movement of cleaning fluid within the cavity 100 induced by the plate described in relation to FIG. 3 acts to carry the device 200 around in a substantially circular path. The circumferential movement of the cleaning fluid is induced by provision of the water feed plate ensures that the cleaning fluid flows uniformly over the water weir lip 34 to clean all portions of the inner collection electrode. It is this existing circumferential movement of the cleaning fluid which is utilised in the illustrated embodiment to induce movement of the cleaning assembly relative to other components of the ESP. The body 210 includes a shaped nose region 215, to reduce frictional fluid resistance to movement of the device within the reservoir. The scraper 220 rests upon the edge of the barrier and acts to dislodge any particulate matter which has accumulated and adhered to the top edge of the barrier 66. Any dislodged particulate matter may fall towards the insulating element 64 and therefore be less likely to impact upon operation of the discharge and collection electrodes or may fall into the cleaning fluid and then pass over the water weir lip 34. The improved clearing of the barrier can help increase the maintenance interval of an electrostatic precipitator.

The scraper 220 in the example shown takes the form of a metal rod or wire, as does stabilising support 230. The wire scraper has a low surface area so that appreciable amounts of particulates or agglomerates cannot adhere to it as it scrapes the edge of the barrier 66. The scraper wire 220 is also held electrically at earth, at least by virtue of direct contact with barrier 66.

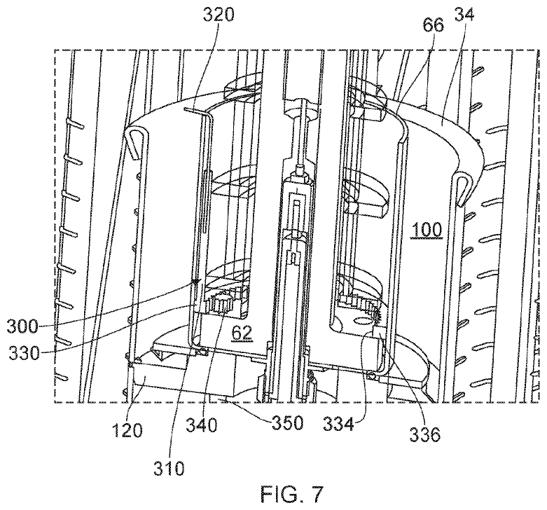

FIG. 7 illustrates an alternative clearing device according to one example embodiment suitable for use in an electrostatic precipitator such as that shown in FIG. 1 and FIG. 2. In this alternative embodiment, the device 300 comprises a body 310 which supports a scraper 320. In the example shown, the device is located inside the barrier 66, between an inner surface of the barrier and the insulating element 64. The body 310 takes the form of an elongate portion connectable at one end to the scraper 320 and at the other to a cog 330. The cog 330 is substantially annular and has a toothed inner ring surface 334 and a smooth outer ring 336 surface. The toothed inner ring surface 334 is configured to engage with cooperating teeth of a drive cog 340, connectable to a rotating drive shaft 350 which extends through the water feed plate 120 along the axis of the precipitator. Rotation of the drive cog 340 causes the device 300 to move around the circumference of the barrier 66. The scraper 320 supported by device body 310 takes the form of a wire which extends over, and engages with, the upper edge of barrier 66, thereby effecting the same scraping and clearing of agglomerates or particulate matter which may have accumulated on the upper edge of the barrier during use of the electrostatic precipitator as described in relation to the example embodiment shown in FIG. 6.

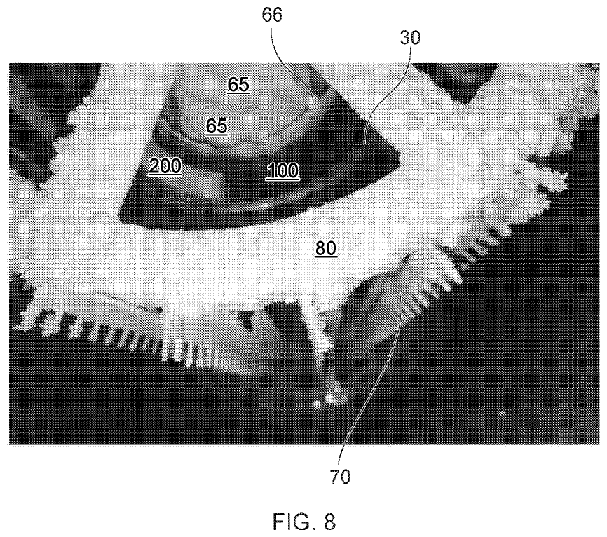

FIG. 8 is a photograph showing some of the main components of a WESP such as that shown in FIGS. 1 and 2, in which a device such as that shown in FIG. 6 is operational. Clearing device 200 can be seen located in the cavity 100 between the inner collection electrode 30 and the barrier 66. Although particulate build up can be seen on, for example, the discharge electrode shafts 70, the annular support 80 and the insulating element plates 65, there is no significant build up at the barrier 66, of the kind which could cause failure or inefficient operation of the electrostatic precipitator.

It will be appreciated that described arrangements are such that an ESP is provided in the form of a WESP. Use of a WESP supports a short-electrode spacing, because water or other fluid can be used to clear at least one primary operational component of the WESP. The normal operating corona current of a WESP is low. It is set at a level which is sufficient to provide the field which causes particles to travel in addition to providing the charging mechanism for these particles.

Aspects recognise that provision of a cleaning device, for example, in the form of a scraper, facilitates clearing of particulate matter which might otherwise build up on a section of the WESP between a water washed weir and an insulator surface. It has been observed that if such particulate build up is not cleared, back-corona or arcing may occur at the operating voltage of the WESP. Aspects recognise that some components, including ancillary components of a WESP, cannot be rapped to dislodge or remove a build up of particulate matter. This can be particularly true in a WESP since particulates may be wet and so cannot be easily dislodged or removed in this manner. Provision of a moving cleaning part, which can be continuously or periodically moving within the WESP can help to avoid particulate build up. Whilst it may intuitively be thought that provision of an additional device or component within the operational zone of a WESP might cause additional debris build up, it has been found that by providing a thin, wire-like mechanical scraper on a moving body, the scraper can clear any particulate build up yet prevent build-up of particulate material on itself or the scraped ancillary component. In In other words, the cleaning device described may help mitigate build up occurring to a degree that could result in undesirable electrical pathways within the WESP.

According to described arrangements, an interface between an insulator and a water washed section of the WESP is cleared. In other words, the ancillary component to be cleared may comprise a component which is not itself an insulator, and may be earthed but unwashed. Aspects provide a mechanism to clear build up which may occur on an ancillary part of a WESP which cannot be washed or rapped.

It will be appreciated that in some described implementations, the cleaning device is powered by tangential water flow already forming part of WESP primary operation and that any debris removed by the cleaning device can be washed away by the tangential water flow already forming part of WESP primary operation. Accordingly, no additional collection hopper for dislodged or cleaned particulate matter is required. Furthermore, provision of appropriate component(s) on the cleaning device may assist water wicking over a weir of the WESP. In the arrangements illustrated, the stabilising support 230 operates to level the cleaning device, thereby reducing resistance to movement of the cleaning device and helping the device slide around the circumference of the WESP, but also acts to provide a path to help water wick evenly over the weir.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A wet electrostatic precipitator comprising an ancillary component cleaning device, the cleaning device comprising:
a cleaning assembly moveably supportable within the wet electrostatic precipitator; the assembly comprising a scraper;
the scraper being configurable to abut an ancillary component of the wet electrostatic precipitator, such that movement of the cleaning assembly within the wet electrostatic precipitator causes movement of the scraper with respect to the ancillary component and wherein the ancillary component comprises a component of a separation assembly provided in the wet electrostatic precipitator to maintain electrical isolation between the discharge and collection electrodes.

2. The wet electrostatic precipitator according to claim 1, wherein movement of the cleaning assembly within the electrostatic precipitator causes movement of the scraper along a surface or edge of the ancillary component.

3. The wet electrostatic precipitator according to claim 1, wherein the scraper comprises a narrow elongate element.

4. The wet electrostatic precipitator according to claim 1, wherein the scraper comprises a wire.

5. The wet electrostatic precipitator according to claim 1, wherein the scraper is electrically earthable.

6. The wet electrostatic precipitator according to claim 5, wherein contact between the scraper and ancillary component causes electrical earthing of the scraper.

7. The wet electrostatic precipitator according to claim 1, wherein the cleaning device is couple to a motor configured to move the cleaning assembly relative to the ancillary component.

8. The wet electrostatic precipitator according to claim 1, wherein the cleaning device is arranged within the electrostatic precipitator such that the cleaning assembly is carried by a flow of cleaning fluid to move the cleaning assembly relative to the ancillary component.

9. The wet electrostatic precipitator according to claim 8, wherein the cleaning fluid comprises a flow of water configured to clean at least one collection electrode surface of the electrostatic precipitator device.

10. The wet electrostatic precipitator according to claim 8, wherein the cleaning fluid comprises a continuous or pulsed flow of gas configured to clean at least one collection electrode surface in the electrostatic precipitator device.

11. A method of cleaning an ancillary component of a wet electrostatic precipitator comprising:
providing a cleaning device comprising a cleaning assembly comprising a scraper;
arranging the cleaning assembly of the cleaning device to be moveably supported within the wet electrostatic precipitator;
configuring the scraper to abut the ancillary component of the wet electrostatic precipitator, such that movement of the cleaning assembly within the wet electrostatic precipitator causes movement of the scraper with respect to the ancillary component and wherein the ancillary component comprises a component of a separation assembly provided in the wet electrostatic precipitator to maintain electrical isolation between the discharge and collection electrodes.
